(19) United States
(12) Patent Application Publication
(10) Pub. No.: US 2024/0126264 A1
(43) Pub. Date: Apr. 18, 2024

(54) MOVING ENVIRONMENT SYSTEM

(71) Applicant: TOYOTA JIDOSHA KABUSHIKI KAISHA, Toyota-shi (JP)

(72) Inventors: Junya OTA, Edogawa-ku (JP); Takatoshi MORIMITSU, Toyota-shi (JP); Ryota KOBAYASHI, Taito-ku (JP); Tatsuya TSUBAKIMOTO, Edogawa-ku (JP); Uori KOIKE, Saitama-shi (JP)

(73) Assignee: TOYOTA JIDOSHA KABUSHIKI KAISHA, Toyota-shi (JP)

(21) Appl. No.: 18/480,705

(22) Filed: Oct. 4, 2023

(30) Foreign Application Priority Data
Oct. 18, 2022 (JP) 2022-167232

(51) Int. Cl. G05D 1/02; E05F 15/73

(52) U.S. Cl. CPC G05D 1/0214; E05F 15/73; G05D 1/0238; E05F 2015/765

(57) ABSTRACT

A moving environment system capable of opening a door in a state in which a robot is away from the door by an appropriate distance while also reducing unnecessary opening of the door is provided. A moving environment system includes: an autonomous mobile robot; and an automatic door including a sensor configured to detect an object that has entered a predetermined detection area, in which the detection area includes a detection area for a passerby and a detection area for an autonomous mobile robot, the detection area for the autonomous mobile robot is set so as to include an area through which a frequency of people passing is equal to or smaller than a predetermined frequency, and the autonomous mobile robot passes through the automatic door via the detection area for the autonomous mobile robot.

### CROSS REFERENCE TO RELATED APPLICATIONS

This application is based upon and claims the benefit of priority from Japanese patent application No. 2022-167232, filed on Oct. 18, 2022, the disclosure of which is incorporated herein in its entirety by reference.

### BACKGROUND

The present disclosure relates to a moving environment system. An automatic door that automatically opens in response to an object that has come close to the door is known. It is required that a sensor mounted on the automatic door appropriately detect an object such as a person who is going to pass through the door. With regard to this automatic door, Japanese Unexamined Patent Application Publication No. 2005-273246 discloses detecting without fail a person such as a child or an object that passes through the door by an antenna and a sensor mounted onto a surface of a plate that forms the door.

### SUMMARY

In the technique in the aforementioned related art, the antenna and the sensor need to be mounted onto the surface of the plate that forms the door, which makes the structure of the door complicated. Meanwhile, with an automatic door having a simple configuration according to the above related art, when a robot is going to pass through an automatic door, the robot needs to come very close to the automatic door, otherwise the door will not open. On the other hand, if the sensor of the automatic door is adjusted in such a way that the sensor is able to detect a robot at an appropriate distance from the automatic door, even objects that are not going to pass through the automatic door will be detected by the sensor, which causes unnecessary opening of the door.

Therefore, it is required to provide a novel technique by which it is possible to open a door in a state in which a robot is away from the door by an appropriate distance, while also reducing the times the door is unnecessarily opened (hereinafter, unnecessary opening of the door).

The present disclosure has been made in view of the aforementioned circumstances, and an aim of the present disclosure is to provide a moving environment system capable of opening a door in a state in which a robot is away from the door by an appropriate distance while also reducing unnecessary opening of the door.

An aspect of the present disclosure in order to accomplish the aforementioned object is a moving environment system including: an autonomous mobile robot; and an automatic door including a sensor configured to detect an object that has entered a predetermined detection area, in which the detection area includes a detection area for a passerby and a detection area for an autonomous mobile robot, the detection area for the autonomous mobile robot is set so as to include an area through which a frequency of people passing is equal to or smaller than a predetermined frequency, and the autonomous mobile robot passes through the automatic door via the detection area for the autonomous mobile robot.

With this moving environment system, it is possible to use a low-traffic area as a special detection area for a robot and to make the robot come close to the automatic door from the detection area. Therefore, it is possible to open a door in a state in which the robot is away from the door by an appropriate distance while also reducing unnecessary opening of the door.

In the aforementioned aspect, the sensor, which is provided in an upper part of the automatic door, may emit light beams to the predetermined detection area, measure a reflected light of the light beams, and thereby detect an object that has entered the predetermined detection area, and the detection area for the autonomous mobile robot may cover a range farther than a range covered by the detection area for the passerby with respect to the position of the automatic door.

With this configuration, in an automatic door including a sensor that is provided in an upper part of the automatic door and emits light beams, it is possible to open the door in a state in which the robot is away from the door by an appropriate distance while also reducing unnecessary opening of the door.

In the aforementioned aspect, the detection area for the autonomous mobile robot may be an area which is along at least one of walls on both sides of the automatic door.

With this configuration, it is possible to easily use a low-traffic area as a detection area for a robot without having to search the low-traffic area in advance or having to provide an area where traffic is prohibited.

In the aforementioned aspect, the detection area for the autonomous mobile robot may be an area which is along, of the walls on both sides of the automatic door, a second wall, which is not a first wall that is adjacent to an opening of the automatic door that is generated just after the automatic door starts to open.

With this configuration, it is possible to prevent a robot from interrupting a movement of a person who is going to pass through an automatic door just after the door starts to open from a space behind the automatic door.

In the aforementioned aspect, the autonomous mobile robot may temporarily suspend a movement for it to pass through the automatic door when there is a person in an area within a predetermined distance from the autonomous mobile robot in the space behind the automatic door after the automatic door opens.

With this configuration, it is possible to prevent a robot from interrupting a movement of a person who passes through the automatic door from a space behind the automatic door more definitely.

According to the present disclosure, it is possible to provide a moving environment system capable of opening a door in a state in which a robot is away from the door by an appropriate distance while also reducing unnecessary opening of the door.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic view showing one example of a configuration of an automatic door according to an embodiment;

FIG. 2 shows a first wall, a second wall, a door panel, a detection area, and an autonomous mobile robot that is going to pass through an automatic door from above;

FIG. 3 shows the first wall, the second wall, the door panel, and the detection area from above;

FIG. 4 is a schematic side view showing one example of the autonomous mobile robot according to the embodiment;

FIG. 5 is a block diagram showing a control apparatus of the autonomous mobile robot according to the embodiment;

FIG. 6 is a block diagram showing one example of a functional configuration of a control apparatus of the autonomous mobile robot;

FIG. 7 is a diagram showing the first wall, the second wall, the door panel, the detection area, and the autonomous mobile robot that is going to pass through the automatic door from above;

FIG. 8 is a diagram showing the first wall, the second wall, the door panel, the detection area, and the autonomous mobile robot that is going to pass through the automatic door from above; and

FIG. 9 is a diagram showing the first wall, the second wall, the door panel, the detection area, and the autonomous mobile robot that is going to pass through the automatic door from above.

### DESCRIPTION OF EMBODIMENTS

Hereinafter, with reference to the drawings, an embodiment of this disclosure will be described in detail. The following descriptions and the drawings are omitted and simplified as appropriate for the sake of clarification of the description. Throughout the drawings, the same components are denoted by the same reference symbols, and redundant description will be omitted as necessary.

A moving environment system according to an embodiment includes an automatic door 20 and an autonomous mobile robot 10.

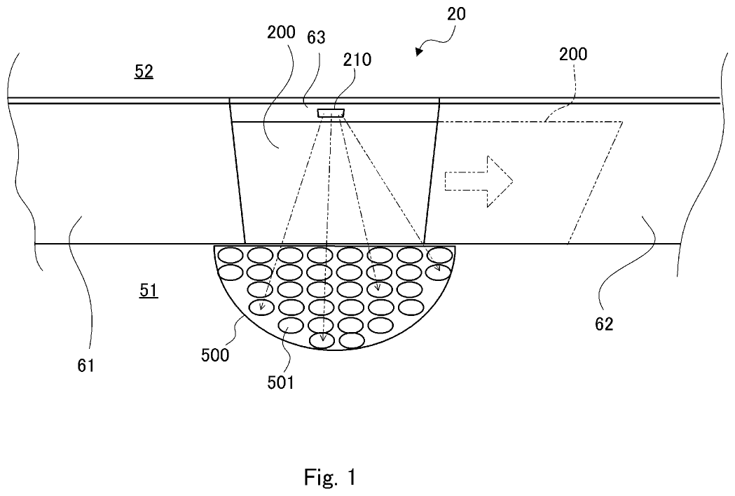

FIG. 1 is a schematic view showing one example of a configuration of the automatic door 20 according to the embodiment. The automatic door 20 includes a door panel 200 that separates a first space 51 from a second space 52 in a moving environment, and a sensor 210 that detects an object that has entered a predetermined detection area 500.

As shown in FIG. 1, the automatic door 20 is provided between a first wall 61 and a second wall 62 that separate the first space 51 from the second space 52. That is, the automatic door 20 is provided so as to be sandwiched by the first wall 61 and the second wall 62. According to this configuration, the automatic door 20 opens or closes a gap between the first wall 61 and the second wall 62 provided to have an interval therebetween by the door panel 200. The door panel 200 is slid in parallel to a surface of this gap (opening surface), thereby closing or opening this gap. That is, opening and closing of the automatic door 20 are thus achieved.

In the example shown in FIG. 1, one door panel 200 moves in one direction (right direction in FIG. 1), so that the automatic door 20 opens. In other words, in the example shown in FIG. 1, the door panel 200 is slid and moves toward one of the two walls on both sides of the automatic door 20 (specifically, the second wall 62), and thereby the automatic door 20 opens. Then, the door panel 200 that has moved to open the automatic door 20 is slid and moves so as to return to its original position, and thereby the automatic door 20 is closed.

In the example shown in FIG. 1, the number of door panels 200 is one. However, the automatic door 20 may include two door panels aligned in a straight line. In this case, the door panel which is provided on the side of the first wall 61 is slid and moves toward the first wall 61 and the door panel which is provided on the side of the second wall 62 is slid and moves toward the second wall 62, and thereby the automatic door 20 opens. In this case as well, the two door panels that have moved to open the automatic door 20 are slid and move so as to return to its original positions, and thereby the automatic door 20 is closed.

The sensor 210 is provided in an upper part of the automatic door 20. More specifically, the sensor 210 is provided above the door panel 200, that is, above the gap closed by the door panel 200. More specifically, the sensor 210 is disposed in a transom 63 that is provided in an upper part of the automatic door 20. As described above, the sensor 210 detects an object that has entered the predetermined detection area 500 in the vicinity of the automatic door 20, that is, in the vicinity of the gap between the first wall 61 and the second wall 62. As will be described later, the detection area 500 is formed of a first partial detection area and a second partial detection area. In this embodiment, the detection area 500 is provided in at least the first space 51. The detection area 500 may be further provided in the second space 52 as well.

The sensor 210 emits light beams to the predetermined detection area 500 and measures the reflected light of the light beams, and thereby detects the object that has entered the detection area 500. The sensor 210 measures an amount of change in the reflected light that is changed depending on the object that has entered the detection area 500, thereby detects the presence of the object. Note that this amount of change may be an amount of change in the reflection time of the reflected light or may be an amount of change in the light-receiving amount. The emitted light beams are, for example, but not limited to, infrared rays such as near-infrared rays.

Specifically, the detection area 500 is formed of a plurality of detection spots 501. That is, the plurality of detection spots 501 are disposed in grids, thereby forming the detection area 500. The sensor 210 emits light beams to each of the detection spots 501 and measures the reflected light for each of the detection spots 501.

The angle of emission of the light beams by the sensor 210 can be arbitrarily changed within a predetermined range. In this embodiment, the user may set the angle of a projector that emits the light beams and the angle of a light receiver that receives the reflected light within a predetermined range in the sensor 210. Therefore, the position of each of the detection spots 501 may be arbitrarily set. That is, the shape of the detection area 500 may be arbitrarily set.

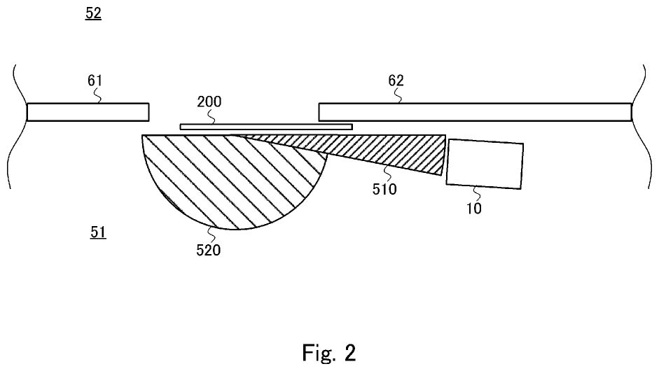

Now, a configuration of the detection area 500 according to this embodiment will be described in more detail. In this embodiment, the detection area 500 has a first partial detection area 510 (a detection area for an autonomous mobile robot) and a second partial detection area 520 (a detection area for a passerby) (see FIG. 2). Here, the first partial detection area 510 is a detection area that is provided assuming that the autonomous mobile robot 10 that is going to pass through the automatic door 20 is detected, and the second partial detection area 520 is a detection area that is provided assuming that a passerby who is going to pass through the automatic door 20 is detected.

FIG. 2 is a schematic view showing one example of the detection area 500. More specifically, FIG. 2 is a diagram showing the first wall 61, the second wall 62, the door panel 200, the detection area 500, and the autonomous mobile robot 10 that is going to pass through the automatic door 20 from above. As shown in FIG. 2, in this embodiment, the first partial detection area 510 covers a range wider (i.e., a range longer/farther) than the range covered by the second partial detection area 520 with respect to the position of the automatic door 20 (the sensor 210). This will be described in more detail with reference to the drawings. The position of the arc of the first partial detection area 510 having a fan shape is farther from the automatic door 20 (the sensor 210) than the position of the arc of the second partial detection area 520 having a fan shape is. While the shape of the first partial detection area 510 and the second partial detection area 520 is a fan shape in the example shown in FIG. 2, they may have another shape. For example, the shape of the first partial detection area 510 and the second partial detection area 520 may be a rectangular shape.

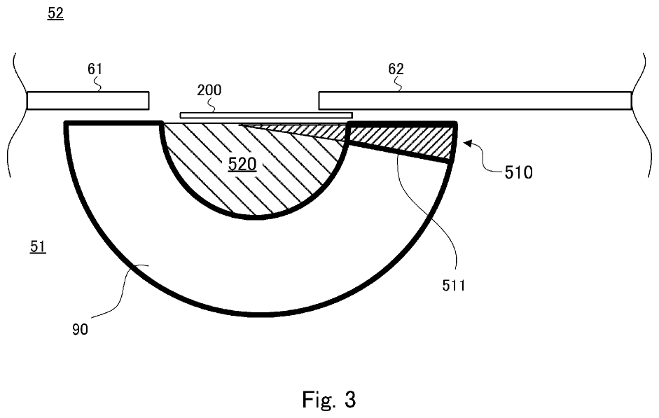

In general, an area closer to the automatic door 20 is likely to be an area through which an object passes before it passes through the automatic door 20. Therefore, in the second partial detection area 520, it is highly likely that only objects that are going to pass through the automatic door 20 will be detected. That is, detection of objects by the second partial detection area 520 is unlikely to cause unnecessary opening of the automatic door 20. Meanwhile, the first partial detection area 510 covers a range far from the automatic door 20, which may cause unnecessary opening of the automatic door 20 to occur depending on the way the first partial detection area 510 is set. In order to prevent this problem, in this embodiment, the first partial detection area 510, in particular, a protruded part of the first partial detection area 510, is set in order to cover an area through which a frequency of people passing is low. In other words, it can be said that the first partial detection area 510 (in particular, its protruded part) is set to be an area through which a frequency of people passing is equal to or smaller than a predetermined frequency. That is, the first partial detection area 510 is set to be an area that is not assumed that people would pass therethrough. Note that the protruded part of the first partial detection area 510 means a part that includes an end away from the automatic door 20 (the sensor 210) and that is protruded in a direction away from the automatic door 20 (the sensor 210) with respect to the second partial detection area 520. For example, the first partial detection area 510 may be set so as to satisfy the following conditions illustrated with reference to FIG. 3. The first partial detection area 510 is set in such a way that a protruded part 511 is disposed in a partial area where the frequency of people passing through per unit area is the smallest in an area 90 that is away from the automatic door 20 by a predetermined distance.

The sensor 210 emits light beams to the first partial detection area 510 and detects an object that has entered the first partial detection area 510. More specifically, the sensor 210 emits light beams to the detection spots 501 that form the first partial detection area 510 and detects the object that has entered the first partial detection area 510. Likewise, the sensor 210 emits light beams to the second partial detection area 520 and detects an object that has entered the second partial detection area 520. More specifically, the sensor 210 emits light beams to the detection spots 501 that form the second partial detection area 520 and detects an object that has entered the second partial detection area 520.

After the sensor 210 detects an object in either one of the first partial detection area 510 or the second partial detection area 520, the automatic door 20 opens the door panel 200. Then, after a predetermined time has passed during which the sensor 210 has not detected any other object in either the first partial detection area 510 or the second partial detection area 520, the automatic door 20 closes the door panel 200.

While the first partial detection area 510 is a detection area for mainly detecting the autonomous mobile robot 10, an object other than the autonomous mobile robot 10, such as a person, which has entered the first partial detection area 510 will also be detected by the sensor 210. Likewise, while the second partial detection area 520 is a detection area for mainly detecting a person, an object other than a person who has entered the second partial detection area 520 will also be detected by the sensor 210. As will be described later, in this embodiment, the autonomous mobile robot 10 enters the first partial detection area 510, but does not enter the second partial detection area 520.

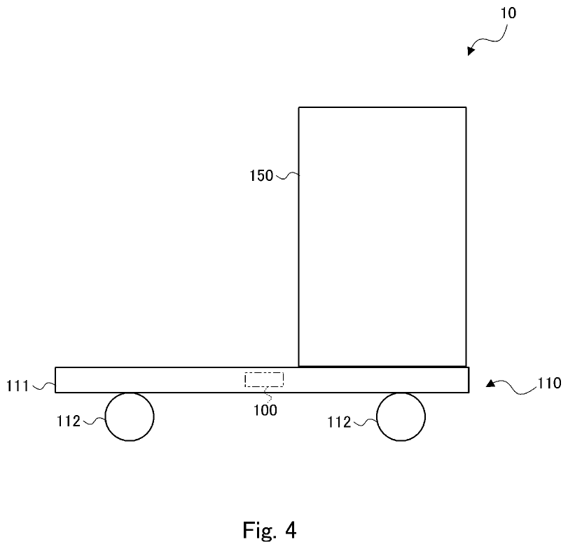

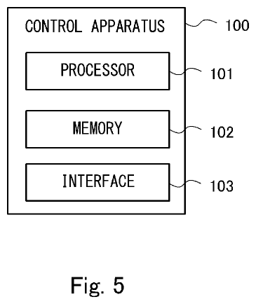

Next, the autonomous mobile robot 10 will be described. FIG. 4 is a schematic side view showing one example of the autonomous mobile robot 10 according to this embodiment. Further, FIG. 5 is a block diagram showing a configuration of a control apparatus 100 of the autonomous mobile robot 10 according to this embodiment.

The autonomous mobile robot 10 is, for example, a robot that autonomously moves within a moving environment such as a house, a facility, a warehouse, a factory, or outdoors. An operation of the autonomous mobile robot 10 is controlled by a control system. While a control apparatus 100 described later of the autonomous mobile robot 10 functions as a control system in this embodiment, some or all of the functions of the control system may be implemented in an apparatus other than the autonomous mobile robot 10, such as a server.

The autonomous mobile robot 10 includes a movement unit 110 that moves the autonomous mobile robot 10, the control apparatus 100 that performs control of the autonomous mobile robot 10 including control of the movement unit 110 or the like, and a rear structure 150. As shown in FIG. 4, in this embodiment, the autonomous mobile robot 10 has a shape in which the front part thereof is lower than the rear part and the rear part is higher than the front side. When the autonomous mobile robot 10 is seen from the side, it has an L shape.

The movement unit 110 includes a vehicle body 111, and wheels 112 disposed in the vehicle body 111 so as to be rotatable. The movement unit 110 rotates the wheels 112 in accordance with a control signal from the control apparatus 100, which allows the autonomous mobile robot 10 to move forward, backward, and rotate. This allows the autonomous mobile robot 10 to move to a desired position. Note that the configuration of the movement unit 110 is merely one example. For example, the number of wheels 112 of the movement unit 110 may be any number, and a desired configuration may be applied as long as the wheels 112 are able to move the autonomous mobile robot 10 to a desired position.

The rear structure 150 is a structure having a predetermined length in the vertical direction. The rear structure 150 may be a rack having a storage space for packages therein. The rear structure 150 is provided on the rear side of the autonomous mobile robot 10. In this embodiment, the autonomous mobile robot 10 moves in a state in which a first structure part (front structure part) having a first height where the rear structure 150 is not provided is on the front side of the traveling direction, and a structure part (rear structure part) having a second height where the rear structure 150 is provided is on the rear side of the traveling direction. That is, the autonomous mobile robot 10 moves in a state in which the low structure part having the first height faces toward the front side of the traveling direction and the high structure part having the second height faces toward the rear side of the traveling direction. Here, the first height is lower than the second height. For example, the first height is lower than one meter. Further, the second height is higher than the first height. For example, the second height is higher than one meter.

Meanwhile, as described above, the sensor 210 emits light beams to the detection area 500 from above the door panel 200 and measures the reflected light of the light beams, and thereby detects an object that has entered the detection area 500. At this time, entrance of the autonomous mobile robot 10 into the detection area 500 is less likely to be detected by the sensor 210 than entrance of a person into the detection area 500 is. That is, when the autonomous mobile robot 10 passes through the automatic door 20, the autonomous mobile robot 10 needs to come very close to the automatic door 20, otherwise the sensor 210 will not respond and the door panel 200 will not open. It is considered that this is due to the size, the shape or the like of the autonomous mobile robot 10. In particular, in this embodiment, as described above, when the autonomous mobile robot 10 enters the detection area 500, it enters the detection area 500 first from the low structure part of the autonomous mobile robot 10. Therefore, the timing of detection by the sensor 210 is especially delayed.

When an adjustment is made so as to enlarge the overall detection range of the sensor 210 so that the sensor 210 will be able to detect the autonomous mobile robot 10 at an appropriate distance from the automatic door 20, the sensor 210 responds even to a person who is not going to pass through the automatic door 20, which causes unnecessary opening of the automatic door 20. Further, in a case where the automatic door 20 opens only after the autonomous mobile robot 10 comes very close to the automatic door 20, detection of a person who is behind the automatic door 20 may be delayed. This is because, if the autonomous mobile robot 10 includes a configuration in which it detects surrounding people by a camera or the like mounted on the autonomous mobile robot 10, it is impossible to recognize the presence of a person who is behind the automatic door 20 until the automatic door 20 starts to open, in other words, until the autonomous mobile robot 10 comes very close to the automatic door 20. If the detection of a person behind the automatic door 20 is delayed, it is possible that the autonomous mobile robot 10 may interrupt movement of the person who is going to pass through the automatic door 20. In this case, in order not to interrupt the movement, the autonomous mobile robot 10 may let the person who is going to pass through the automatic door 20 from behind the automatic door 20 to pass through the automatic door 20 first. However, this may require the autonomous mobile robot 10 to move rearward. However, if there is another person or the like behind the autonomous mobile robot 10, the autonomous mobile robot 10 cannot move rearward, and thus the autonomous mobile robot 10 cannot let the person who is going to pass through the automatic door 20 from behind the automatic door 20 to pass through the automatic door 20 first. In view of this background, it is required to provide a technique capable of opening the automatic door 20 in a state in which the autonomous mobile robot 10 is away from the automatic door 20 by an appropriate distance while also reducing unnecessary opening of the automatic door 20.

With reference to FIG. 5, a description of the configuration of the autonomous mobile robot 10 will be given again.

The control apparatus 100, which is an apparatus that controls the autonomous mobile robot 10, includes a processor 101, a memory 102, and an interface 103. The processor 101, the memory 102, and the interface 103 are connected to one another via a data bus or the like.

The interface 103 is an input/output circuit that is used to communicate with another apparatus such as the movement unit 110.

The memory 102 is formed of, for example, a combination of a volatile memory and a non-volatile memory. The memory 102 is used to store software (computer program) including one or more instructions executed by the processor 101, and data or the like used for various kinds of processing of the autonomous mobile robot 10.

The processor 101 loads the software (computer program) from the memory 102 and executes the loaded software (computer program), thereby performing the following processing of the control apparatus 100.

The processor 101 may be, for example, a microprocessor, a Micro Processor Unit (MPU), a Central Processing Unit (CPU) or the like. The processor 101 may include a plurality of processors.

As described above, the control apparatus 100 is an apparatus that functions as a computer.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

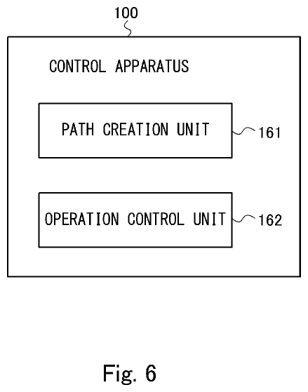

FIG. 6 is a block diagram showing one example of a functional configuration of the control apparatus 100 of the autonomous mobile robot 10. As shown in FIG. 6, the control apparatus 100 includes a path creation unit 161 and an operation control unit 162.

The path creation unit 161 creates a moving path of the autonomous mobile robot 10. In this embodiment, the path creation unit 161 creates, for example, a moving path including a movement from the first space 51 (the space which is in front of the automatic door 20 when seen from the autonomous mobile robot 10) to the second space 52 (the space behind the automatic door 20 when seen from the autonomous mobile robot 10), which is the moving path when the autonomous mobile robot 10 passes through the automatic door 20. However, when the path creation unit 161 creates a moving path for passing through the automatic door 20, the path creation unit 161 creates a moving path that passes through the automatic door 20 via the first partial detection area 510, which is the detection area for the autonomous mobile robot. That is, the path creation unit 161 creates a moving path including a path to enter the first partial detection area 510 of the detection area 500. While the autonomous mobile robot 10 includes the path creation unit 161 in this embodiment, the path of the autonomous mobile robot 10 may be created by an external apparatus (e.g., a server or the like) of the autonomous mobile robot 10.

The operation control unit 162 controls an operation of the autonomous mobile robot 10. Specifically, the operation control unit 162 mainly controls the operation of the movement unit 110. The operation control unit 162 is able to control the rotation of the wheels 112 by transmitting a control signal to the movement unit 110, and move the autonomous mobile robot 10 to a desired position.

The operation control unit 162 may control the movement of the autonomous mobile robot 10 by performing known control such as feedback control or robust control based on rotation information on the wheels 112 detected by the rotation sensor provided in the wheels 112. Further, the operation control unit 162 may autonomously move the autonomous mobile robot 10 by controlling the movement unit 110 based on information such as distance information detected by a camera or a distance sensor such as an ultrasonic sensor provided in the autonomous mobile robot 10, or map information of the moving environment.

In this embodiment, in particular, the operation control unit 162 controls movement of the autonomous mobile robot 10 in such a way that the autonomous mobile robot 10 moves along the moving path created by the path creation unit 161. Accordingly, when the autonomous mobile robot 10 moves to pass through the automatic door 20, the operation control unit 162 controls the movement operation of the autonomous mobile robot 10 so that the autonomous mobile robot 10 passes through the automatic door 20 via the first partial detection area 510, which is the detection area for the autonomous mobile robot.

As described above, in this embodiment, the first partial detection area 510 is an area that covers a range wider (i.e., a range longer/farther) than the range covered by the second partial detection area 520. Therefore, the distance between the automatic door 20 and the autonomous mobile robot 10 at the timing when the sensor 210 has detected the autonomous mobile robot 10 in a case where the autonomous mobile robot 10 enters the first partial detection area 510 and passes through the automatic door 20 is longer than that in a case where the autonomous mobile robot 10 enters the second partial detection area 520 and passes through the automatic door 20. Further, in this embodiment, the first partial detection area 510 is set to be an area through which a frequency of people passing is low. Accordingly, according to this embodiment, the automatic door 20 can be opened in a state in which the autonomous mobile robot 10 is away from the automatic door 20 by an appropriate distance while also reducing unnecessary opening of the automatic door 20.

In particular, as shown in FIG. 2, the first partial detection area 510 is preferably an area along at least one of the first wall 61 and the second wall 62 on both sides of the automatic door 20. In general, an area along walls is a low-traffic area. Therefore, since the first partial detection area 510 is provided in an area along a wall, it is possible to easily use the low-traffic area as the detection area for the robot without having to search the low-traffic area in advance or having to provide an area where traffic is prohibited. Note that an area along a wall is specifically an area whose distance from a wall is within a predetermined distance D, and the distance D is, for example, a predetermined distance of equal to or smaller than 1 m.

Further, in particular, as shown in FIG. 2, the first partial detection area 510 is preferably an area which is along the second wall 62, which is not the first wall 61 that is adjacent to the opening of the automatic door 20 that is generated just after the automatic door 20 starts to open, of the walls on both sides of the automatic door 20. That is, the first partial detection area 510 is preferably an area along a wall, which is on the side opposite from the side where the automatic door 20 starts to open. In FIG. 2, when the automatic door 20 starts to open, the door opens from the left side. Therefore, the first partial detection area 510 is preferably provided along the second wall 62, which is a wall on the right side. This is because, with this configuration, it is possible to prevent the autonomous mobile robot 10 from interrupting the movement of a person who passes through the automatic door 20 just after the door starts to open from the space behind the automatic door 20 (second space 52). A person who cannot wait for the automatic door 20 to fully open tries to pass through the gap between the first wall 61 and the door panel 200 as soon as the automatic door 20 starts to open. Therefore, the autonomous mobile robot 10 preferably moves from the second wall 62 to the automatic door 20 so that it is possible to reduce the possibility that the autonomous mobile robot 10 may interrupt the movement of people compared to the case where the autonomous mobile robot 10 moves from the first wall 61 toward the automatic door 20. Therefore, it is more preferable to provide the first partial detection area 510 along the second wall 62.

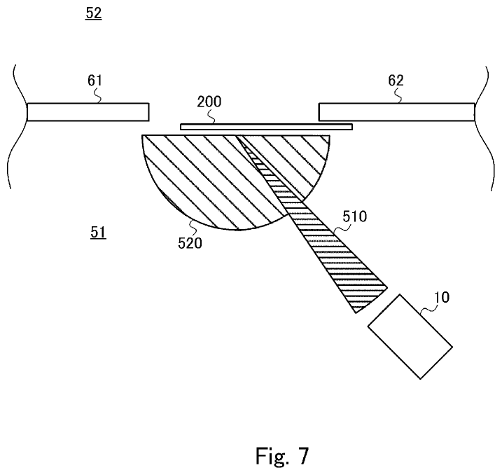

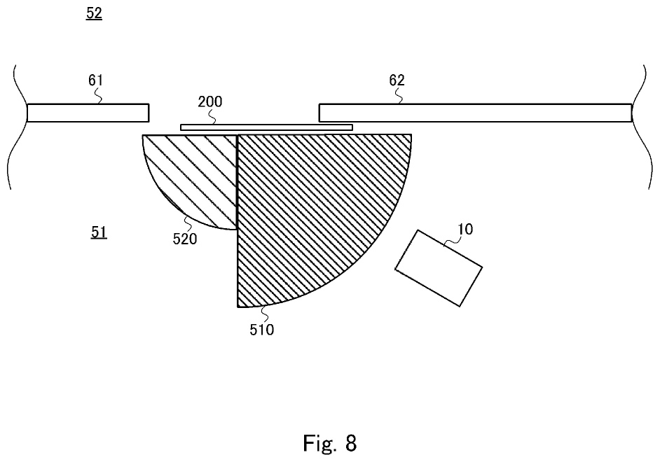

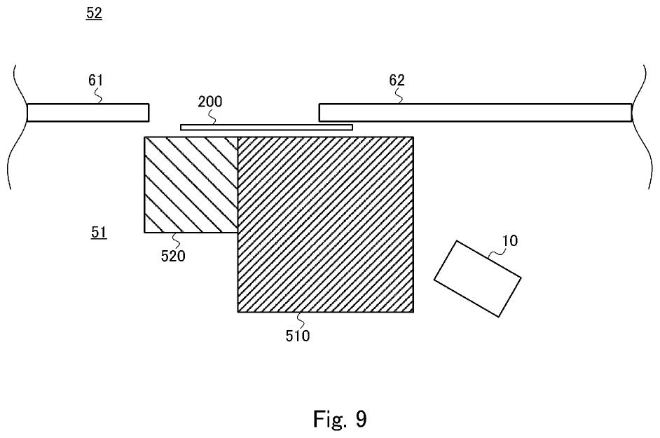

Note that, while the first partial detection area 510 is provided so as to be along one of the walls on both sides of the automatic door 20 in this embodiment, two first partial detection areas 510 may be provided so as to be along the respective walls on both sides of the automatic door 20. In this manner, the detection area 500 may include a plurality of first partial detection areas 510. Further, for example, the first partial detection area 510 may not necessarily be provided along one of the walls on both sides of the automatic door 20, as shown in FIG. 7. In this case, the first partial detection area 510 may be set by searching a low-traffic area in advance or providing an area where traffic is prohibited. Further, while the first partial detection area 510 is narrower than the second partial detection area 520 in the examples shown in FIGS. 2 and 7, for example, the first partial detection area 510 may have a size equal to or larger than the second partial detection area 520, as shown in FIG. 8. Further, the shape of the first partial detection area 510 and the second partial detection area 520 may not necessarily be a fan shape. For example, the shape of the first partial detection area 510 and the second partial detection area 520 may be a rectangular shape, as shown in FIG. 9.

Further, when there is a person within a predetermined distance from the autonomous mobile robot 10 in the space behind the automatic door 20 (the second space 52) after the automatic door 20 opens, the operation control unit 162 of the autonomous mobile robot 10 may perform control for temporarily suspending the movement for it to pass through the automatic door 20. With this configuration, it is possible to prevent the autonomous mobile robot 10 from interrupting the movement of a person passing through the automatic door 20 from the space behind the automatic door 20 more definitely.

The embodiment has been described above. In the moving environment system according to this embodiment, the detection area 500 of the automatic door 20 includes the first partial detection area 510 (the detection area for the autonomous mobile robot) and the second partial detection area 520 (the detection area for the passerby), and the autonomous mobile robot 10 passes through the automatic door 20 via the first partial detection area 510. Accordingly, with this moving environment system, it is possible to use a low-traffic area as a special detection area for a robot, and make the autonomous mobile robot 10 come close to the automatic door from this detection area. Therefore, it is possible to open a door in a state in which the robot is away from the door by an appropriate distance while also reducing unnecessary opening of the door. In this embodiment, in particular, it is possible to obtain the aforementioned effect with a simple configuration.

Further, the present disclosure is not limited to the aforementioned embodiment and may be changed as appropriate without departing from the spirit of the present disclosure.

Further, the whole or part of the embodiment disclosed above can be described as, but not limited to, the following supplementary notes.

### Supplementary Note 1

A moving environment system comprising:
an autonomous mobile robot; and
an automatic door including a sensor configured to detect an object that has entered a predetermined detection area, wherein
the detection area includes a detection area for a passerby and a detection area for an autonomous mobile robot,
the detection area for the autonomous mobile robot is set so as to include an area through which a frequency of people passing is equal to or smaller than a predetermined frequency, and
the autonomous mobile robot passes through the automatic door via the detection area for the autonomous mobile robot.

### Supplementary Note 2

The moving environment system according to Supplementary Note 1, wherein
the sensor, which is provided in an upper part of the automatic door, emits light beams to the predetermined detection area, measures a reflected light of the light beams, and thereby detects an object that has entered the predetermined detection area, and
the detection area for the autonomous mobile robot covers a range farther than a range covered by the detection area for the passerby with respect to the position of the automatic door.

### Supplementary Note 3

The moving environment system according to Supplementary Note 1 or 2, wherein the detection area for the autonomous mobile robot is an area which is along at least one of walls on both sides of the automatic door.

### Supplementary Note 4

The moving environment system according to Supplementary Note 3, wherein the detection area for the autonomous mobile robot is an area which is along a second wall, which is not a first wall that is adjacent to an opening of the automatic door that is generated just after the automatic door starts to open, the first wall and the second wall being the walls on both sides of the automatic door.

### Supplementary Note 5

The moving environment system according to any one of Supplementary Notes 1 to 4, wherein the autonomous mobile robot temporarily suspends a movement for it to pass through the automatic door when there is a person in an area within a predetermined distance from the autonomous mobile robot in the space behind the automatic door after the automatic door opens.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A moving environment system comprising:
an autonomous mobile robot; and
an automatic door including a sensor configured to detect an object that has entered a predetermined detection area, wherein
the detection area includes a detection area for a passerby and a detection area for an autonomous mobile robot,
the detection area for the autonomous mobile robot is set so as to include an area through which a frequency of people passing is equal to or smaller than a predetermined frequency, and
the autonomous mobile robot passes through the automatic door via the detection area for the autonomous mobile robot.

2. The moving environment system according to claim 1, wherein the sensor, which is provided in an upper part of the automatic door, emits light beams to the predetermined detection area, measures a reflected light of the light beams, and thereby detects an object that has entered the predetermined detection area, and
the detection area for the autonomous mobile robot covers a range farther than a range covered by the detection area for the passerby with respect to the position of the automatic door.

3. The moving environment system according to claim 1, wherein the detection area for the autonomous mobile robot is an area which is along at least one of walls on both sides of the automatic door.

4. The moving environment system according to claim 3, wherein the detection area for the autonomous mobile robot is an area which is along a second wall, which is not a first wall that is adjacent to an opening of the automatic door that is generated just after the automatic door starts to open, the first wall and the second wall being the walls on both sides of the automatic door.

5. The moving environment system according to claim 1, wherein the autonomous mobile robot temporarily suspends a movement for it to pass through the automatic door when there is a person in an area within a predetermined distance from the autonomous mobile robot in the space behind the automatic door after the automatic door opens.
